(19) United States
(12) Patent Application Publication
(10) Pub. No.: US 2009/0274644 A1
(43) Pub. Date: Nov. 5, 2009

(54) Ant Eradication Composition and Method

(76) Inventor: Sara Rees, Weston, FL (US)

Correspondence Address: ROBERT M. SCHWARTZ, P.A., P.O. BOX 221470, HOLLYWOOD, FL, 33022, US

(21) Appl. No.: 12/397,400

(22) Filed: Mar. 4, 2009

Related U.S. Application Data
(60) Provisional application No. 61/126,016, filed on May 1, 2008.

(51) Int. Cl. A01N 25/00; A01P 7/04

(52) U.S. Cl. 424/84

(57) ABSTRACT

A composition and method for eradicating ants is provided wherein the composition includes borax, sugar and yeast. The messenger ants taste the composition; the workers take the composition back to the Queen who also eats the composition. The composition renders her infertile, and later distends the gastrointestinal tract.

### INDEX TO RELATED APPLICATIONS

This application claims the benefit of U.S. Provisional Patent No. 61/126,016 filed May 1, 2008 the disclosure of which is incorporated herein by reference in its entirety.

### BACKGROUND OF THE INVENTION

Ants are often found in and around food. Methods to control ants have been evaluated based on effectiveness against the ants, environmental safety and ease of use, especially for pest control operators concerned with ant population management. Ants have been controlled in the field by use of sprays or dusts, methods that are considered by many to be environmentally unfriendly. Furthermore, exposure of the spray or dust to environmental elements may limit the effectiveness of the toxicant, for example, by rain washing it away.

A “cleaner,” more effective method of control is to place a toxic bait in an ant station so as to prevent exposure to non-target organisms, such as children and pets, and to shield the bait from environmental factors that may cause degradation and dilution of the toxicant. While non-particulate solid baits are potentially safer than liquids, powders, or granular materials, they generally are not suitable for use in rebaitable, semi-enclosed ant stations. Typically, when such solid baits have been depleted, the entire self-contained station must be replaced.

A better more effective method, and a novel one is to place bait in a more sophisticated manner that creates a closed circuit that doesn't allow the ants an escape the bait.

Preferred toxicants are ones that do not actually kill the colony, but rather render the Queen infertile and thus the colony comes to an end. The task of workers ants is to take care of future generations. When this task ends the colony disintegrates. The workers die from lack of work or move away.

Ants are selective in their preference for baits. What one species of ant finds appealing, another species may ignore.

This bait is favored by most ants.

A suitable toxicant is one that is both toxic to the ant, renders the Queen infertile, and is slow acting so that the ant will distribute the toxicant to their Queen.

1. It is an object of this invention to provide a highly effective ant bait composition.

2. It is a further object of this invention to provide a bait formulation that is attractive to the ants and be readily used in baiting an ant station, by anyone, such as housewife, hospital maintenance personal, recreational maintenance personal, with ease, and without danger, including a pest control operators.

3. It is a farther object of this invention to provide a non-toxic, none allergenic bait that's not dangerous for children and pets.

4. It is a further object of this invention to provide a none odorous, indoor and out door safe product.
highly effective ant bait
none toxic bait
none allergenic, none odorous bait
indoor environmentally safe for pets and children
Outdoor safe from exposure to the elements, such as rain and dust.
re-baitable containers.
it has no expiration date
it does not loose effectiveness over time.

It is not desirable that the composition immediately kill the messenger ants, rather, that the composition renders the queen infertile and thus brings the colony to an end.

### BRIEF SUMMARY OF THE INVENTION

The present invention is a novel composition and a novel method for exterminating and eliminating ants. A typical ant colony is formed of messenger ants, workers and a Queen. It is desirable that the messenger ants ingest the composition and live. Messenger ants taste the food to see that it is safe for their Queen. A highly toxic bait would kill only some ants and not the queen. This composition allows the workers to gather and bring food by mouth back to the Queen. The Queen ingests the composition and becomes infertile, and later also dies. The death of the Queen ant typically means the death of the colony.

In a preferred embodiment, death of the Queen occurs in a period up to about 3 hours.

After the queen's death the remaining ants move away in search of a new colony with a live queen. Since their mission in life is to serve the queen once the queen is dead they need a new queen.

Sugar is a sweet crystalline or powdered substance, white when pure, consisting of sucrose obtained mainly from sugar cane and sugar beets. Sugar refers to any of a class of water-soluble crystalline carbohydrates, including sucrose and lactose, having a characteristically sweet taste and classified as monosaccharides, disaccharides, and trisaccharides. The present composition contemplates use of the term sugar to encompass all molecules and combinations thereof commonly associated with the term.

Borax is a complex borate mineral that is found in playa lakes and other evaporite deposits. The basic structure of borax contains chains of interlocking BO₂(OH) triangles and BO₃(OH) tetrahedrons bonded to chains of sodium and water octahedrons. According to the website www.borax.com, “borax” refers to both disodium tetraborate decahydrate (Na₂B₄O₇-10H₂O) and disodium tetraborate pentahydrate (Na₂B₄O₇-5H₂O) salts unless otherwise indicated. Borax, as used herein, refers to any single or combination of compounds as the name is commonly used.

Yeast, most commonly Saccharomyces cerevisiae, is used in baking as a leavening agent, where it converts the fermentable sugars present in the dough into carbon dioxide. In bread baking, the formation of carbon dioxide causes dough to expand or rise as the carbon dioxide forms pockets or bubbles. The present invention utilizes yeast and related carbon dioxide formation in a composition and method to eradicate ants.

The combination of borax, oil and sugar makes the queen infertile.

The bait does 2 things: 1. it makes the queen infertile and thus brings an end to the colony. 2. the yeast eventually kills the ants including the queen.

The present invention has improved upon the use of borax as an ant eradicating agent. Incorporation of yeast into the composition of the present invention has shown to significantly improve the efficacy of the composition. Ants that ingest the composition containing yeast have been observed to bring the composition to the Queen and eliminate a colony in a short time. Preferably, death occurs within about three hours.

The yeast in the composition of the present invention reacts in the stomach of each individual ant and produces gas during digestion that subsequently distends the gastrointestinal tract of the ant. The distendation of the gastrointestinal tract occurs over short time but not instantly, and thus provides an opportunity for the worker or messenger ants to feed the composition to the Queen prior to their own demise. The Queen ingests the composition provided to her by the messenger ants and experiences similar distendation of her gastrointestinal tract that ultimately leads to her death. In an ant colony, the death of the Queen results in death of the colony.

The present invention also provides for a method by which a composition according to the present invention is prepared and placed into bait traps that will subsequently eradicate a colony in a short time.

Vials containing the composition of the present invention are placed about the perimeter of the area to be treated, as shown in FIG. 4.

### BRIEF DESCRIPTION OF THE DRAWINGS

FIG. 1 is a perspective view of the composition in holder with cap removed and arrows indicating cap placement.

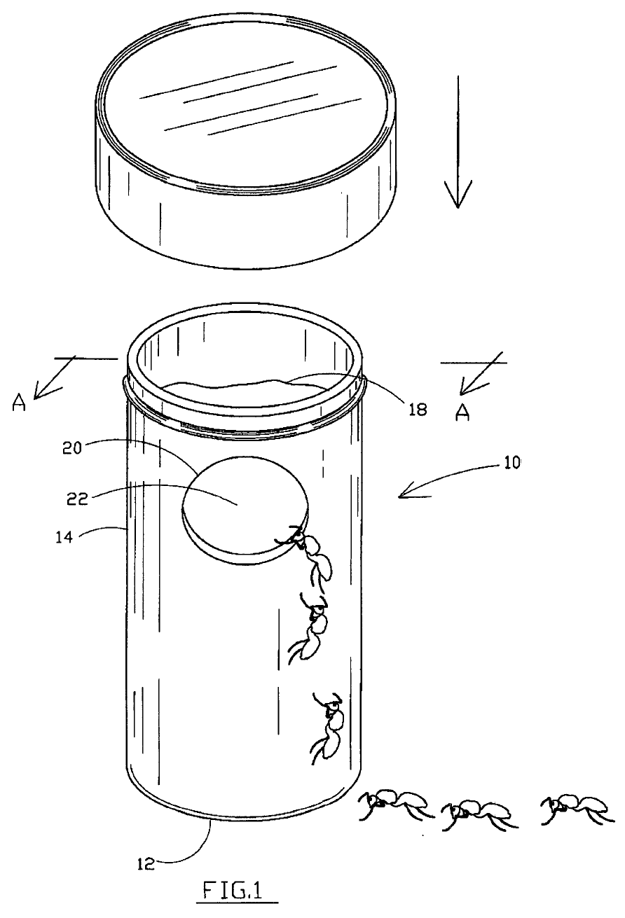

FIG. 2 is a cross section along line A-A from FIG. 1.

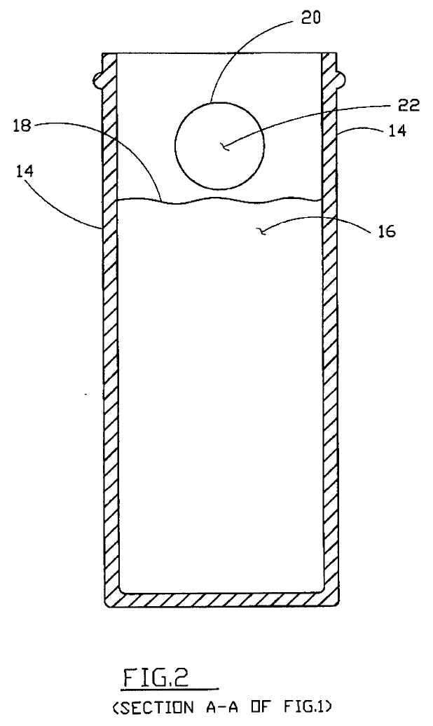

FIG. 3 shows commercial packaging with a large supply vial and four distribution vials stored therein.

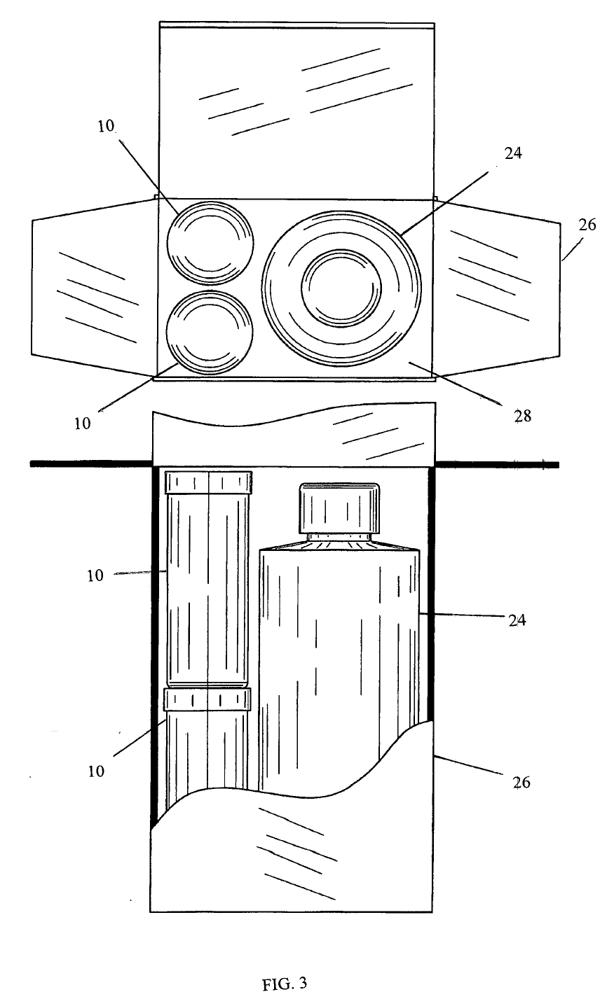

FIG. 4 shows placement of vials about the perimeter of an area to be treated.

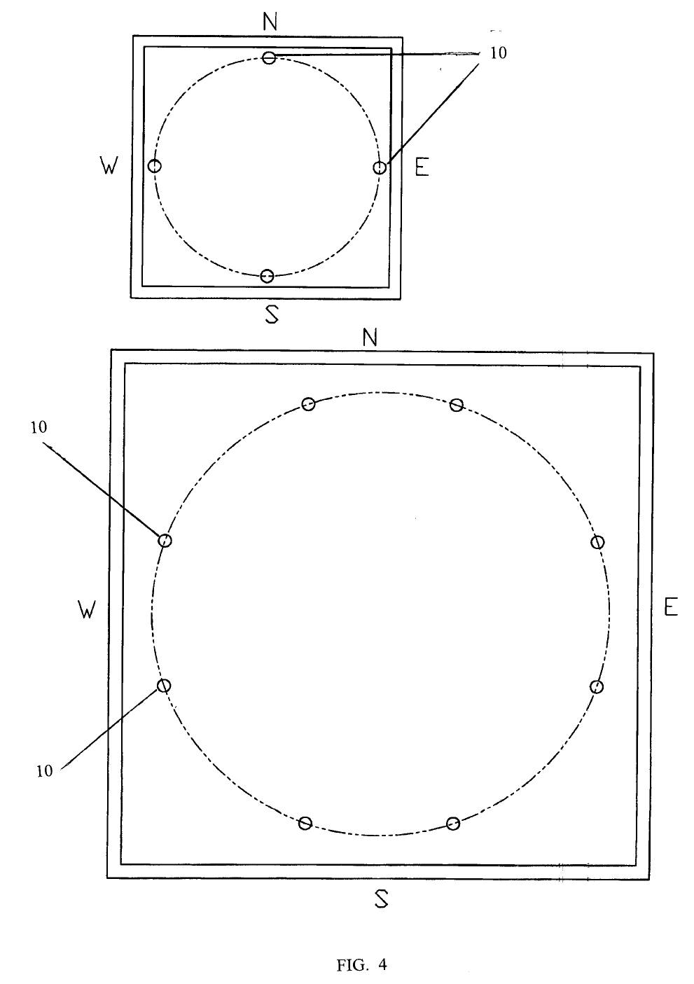

FIG. 5 is one embodiment of commercial packaging.

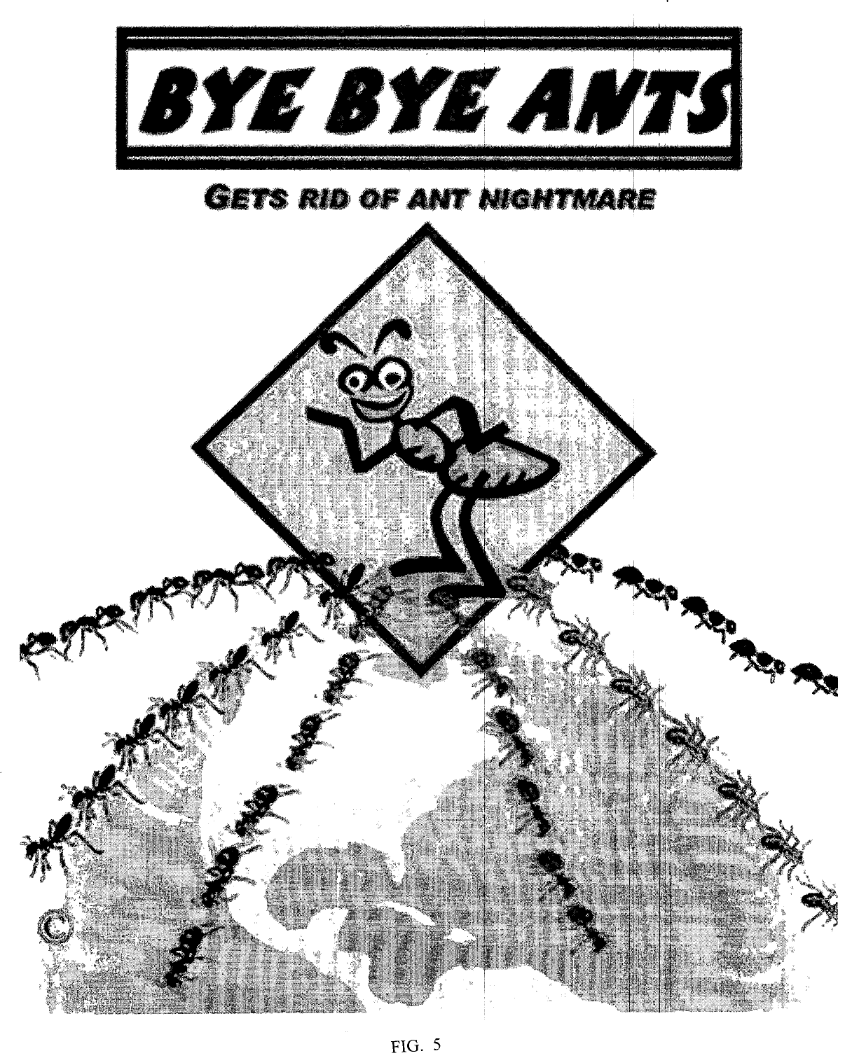

### DETAILED DESCRIPTION OF THE PREFERRED EMBODIMENTS

In a preferred embodiment an ant bait holder 10 has base 12 and circumferential side wall 14. A composition 16 is placed in holder 10. Holder 10 has an opening 20 in side wall 14. When placed inside holder 10, composition 16 has an upper surface 18 that is below opening 20. Ants enter opening 20 through orifice 22, remove composition 16 and bring removed composition 16 back to the colony queen.

Preferably a package 26 contains a supply bottle 24 and holders 10 placed in the interior 28 of said package 26.

In a preferred embodiment the composition for treating ants according to the present invention is contained in the following examples:

### Example 1

### The Composition is Formed of

a. 50-70% water;
b. 8-12% borax;
c. 30-40% sugar;
d. 3-8% corn oil, cottonseed oil, or combinations thereof;
e. 1-5% yeast;
f. 0-10% guava paste

### Example 2

### The Composition is Formed of

(a) 45-65% water;
(b) 8-12% borax;
(c) 15-25% sugar;
(d) 3-8% corn oil;
(e) 1-5% yeast;
(f) 1-10% guava paste

When the ants ingest composition 16 containing yeast, as described herein, carbon dioxide forms in the gastrointestinal tract of each individual ant. The formation of the gas occurs over a period of time and slowly distends the gastrointestinal tract which extends to the ant's body and causes death. This manner of death occurs over an extended period of time that is relatively short. In one embodiment, the death occurs in up to about 3 hours. Because the death occurs over an extended period of time, the messenger ants that ingest composition 16 and bring composition 16 back to the colony Queen have sufficient time to bring the composition back to the colony queen so the colony Queen may also die from ingesting composition 16.

Studies of administering the composition have observed eradication of a colony in about three hours.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A composition for treating ants comprising:
a. 50-70% water;
b. 8-12% borax;
c. 30-40% sugar;
d. 3-8% corn oil, cottonseed oil, or combinations thereof; and
e. 1-5% yeast;
wherein said composition is used as a bait for the delayed killing of ants.

2. The composition of claim 1 further comprising guava paste.

3. A method of killing ants comprising the steps of:
a. preparing a composition according to claim 1;
b. placing the composition in a location accessible to ants; wherein said placement encompasses at least four points substantially about the perimeter of the are to be treated;
c. allowing ants to access and ingest said composition;
d. waiting for said ingestion to produce carbon dioxide gas in said ants' gastrointestinal tract such that said gas distends the gastrointestinal tract and kills the ants.

4. The method of claim 3 wherein said access includes access by colony messenger ants that taste the combination and live, and worker ants that transport said composition to a colony queen rendering said queen infertile.

5. The method of claim 3 wherein said access includes placement of said composition in a bait housing having an opening accessible to ants.
